(19) United States
(12) Patent Application Publication
(10) Pub. No.: US 2009/0239036 A1
(43) Pub. Date: Sep. 24, 2009

(54) Slip-Resistant Detectable Warning Tiles and Method for Manufacture

(75) Inventors: Georg R. Becker, Tucson, AZ (US); Thomas R. Fritsch, Tucson, AZ (US)

Correspondence Address: QUARLES & BRADY LLP, ONE SOUTH CHURCH AVENUE, SUITE 1700, TUCSON, AZ, 85701-1621, US

(73) Assignee: StrongGo LLC, Tucson, AZ (US)

(21) Appl. No.: 12/053,166

(22) Filed: Mar. 21, 2008

(51) Int. Cl. B32B 13/02; B32B 38/06

(52) U.S. Cl. 428/143; 264/259

(57) ABSTRACT

Apparatus and processes that include tiles having a roughened top side of grit. The grit on the top surface imparts a durable and slip-resistant property to the tile.

### BACKGROUND OF THE INVENTION

1. Field of the Invention

This invention relates to an apparatus and process for improved manufacture of detectable warning tiles resulting in a product with high slip resistance.

2. Description of the Related Art

A tile is a manufactured piece of hard-wearing material such as ceramic, cement, stone, metal, plastic, or glass. Flooring tiles in particular are commonly made of ceramic, clay, or stone. Traditionally, floor tiles have typically been set into mortar or “grout,” which consists at least of water, sand, and cement (with polymers, color tint, and other additives being common).

More specialized flooring tiles exist in which a protuberance (such as a truncated dome or stud) extends from the top surface of the tile and provides a “detectable warning” of a potentially dangerous situation, such as the end of a curb or the entry to an escalator. In the United States, the installation of such “detectable warning tiles” on sidewalks, street crossings, curb ramps, hazardous vehicular ways, and transit platform edges is mandated to allow accessibility to buildings and facilities by individuals with disabilities under the Americans with Disabilities Act (ADA) of 1990.

In today's market, plastic and metal are two common types of detectable warning tiles being manufactured. Both materials are prone to have low slip-resistance properties.

Attaching small bumps or other regular and smooth protuberances on the surface of the detectable warning tiles increase the slip resistance on tiles made of plastic or metal. However, a deficiency of this solution is that eventually these bumps or obstacles wear off rapidly or break exposing a surface that then becomes increasingly slippery.

Thus, there continues to be a need for improved tiles and methods for high slip resistance detectable warning tiles that offer improved durability and that are especially well suited for high slip resistant areas.

### SUMMARY OF INVENTION

A tile with high slip resistance can be achieved by a manufacturing process that results in a product with a surface of high friction. This high friction surface can be achieved by machining the mold or otherwise by imparting grit to the top surface of the tile. The machining of the mold can be any pattern or method resulting in an abrasive surface of grit. The particle diameter of the grit can range in grit from 1 to 3000 micrometers.

Thus, the invention relates to a tile having high slip resistance by machining or applying grit to the mold and applying the mold to the top surface of the tile. The grit may be transferred to the tile or imprinted thereon by the mold or another implement during the manufacturing process (e.g., a stamp).

Accordingly, the invention provides a novel method and means for increasing and maintaining the overall slip resistance of tiles, and especially truncated detectable warning tiles, during wet weather conditions and other hazardous situations. Furthermore, the invention provides a method and means for creating truncated detectable warning and other tiles that are manufactured via a mold or a similar process that results in a tile product that has improved slip resistance.

Truncated detectable warning tiles are composed of materials, such as plastic, ceramic, metal, glass, and other composites, that can become slippery. Applying grit to or imprinting grit on the detectable warning tile minimizes or eliminates that potential slip hazard.

The advantages of the invention are significant because it will be safer to walk on tiles such as detectable warning tiles during any weather condition and the process for making a truncated detectable warning tile will result in a lasting, inherently high-slip resistant product without the need of any post-manufacturing surface modification step or additional of slip-resistant material or coatings.

In one embodiment, the grit is disposed within a mold and may comprise sand paper that imprints grit texture upon a tile during the manufacturing process to increase the slip-resistance of the top surface.

In another embodiment, a high friction grit pattern is machined directly into the mold resulting in a tile surface with high slip resistance.

A tile of the invention may further include a plurality of protuberances on the top side, thereby providing a detectable warning tile. The plurality of protuberances preferably form a regularly arranged pattern or array, which, in one embodiment, includes one or more structures selected from the group consisting of studs, domes, and truncated domes. Grit also be imparted to the protuberances to further improve slip resistance.

Thus, it will be appreciated that the apparatus and methods of the invention provide new and improved tiles and manufacturing processes.

### BRIEF DESCRIPTION OF THE DRAWINGS

FIG. 1 illustrates a top elevational view a prior tile design.

FIG. 2 schematically illustrates a perspective view an embodiment of the invention.

FIGS. 3A and 3B is side cross-section view of the embodiment shown in FIG. 1.

FIG. 4 illustrates in flow diagram the basic steps involved in manufacturing methods of the invention.

### DETAILED DESCRIPTION OF THE PREFERRED EMBODIMENTS

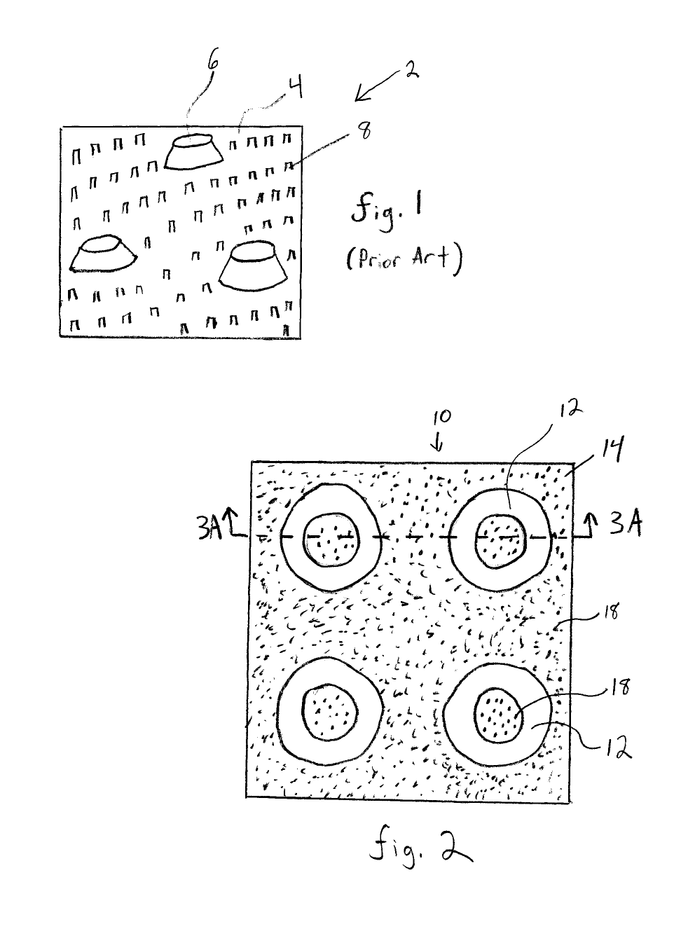

Turning to FIG. 1, a simplified drawing of a section of a related-art tile design is shown. While many other prior tile designs are known, this particular tile 2 includes a planar structure 4 upon which truncated domes 6 are disposed. Thus, the tile 2 may function as a detectable warning tile. Such tiles typically are made of plastic or metal that have low slip-resistance properties. Accordingly, raised bumps or cylinders 8 have been molded onto tile 2 in order to increase the tile's slip resistance. However, the cylinders 8 tend to wear rather rapidly and can lead to a situation in which tile 2 must be repaired or replaced in order to maintain feasibly slip resistance.

FIG. 2 schematically illustrates an embodiment of the invention. As seen from a top view, the tile 10 includes a plurality of protuberances 12 on the top side 14. The plurality of protuberances 12 may form an array of one or more structures selected from the group consisting of studs, domes, and truncated domes. While a preferred array of protuberances is a 3×3 matrix, more or fewer domes may be disposed upon the tile. Disposed upon the top side 14 of the tile 10 is grit 18.

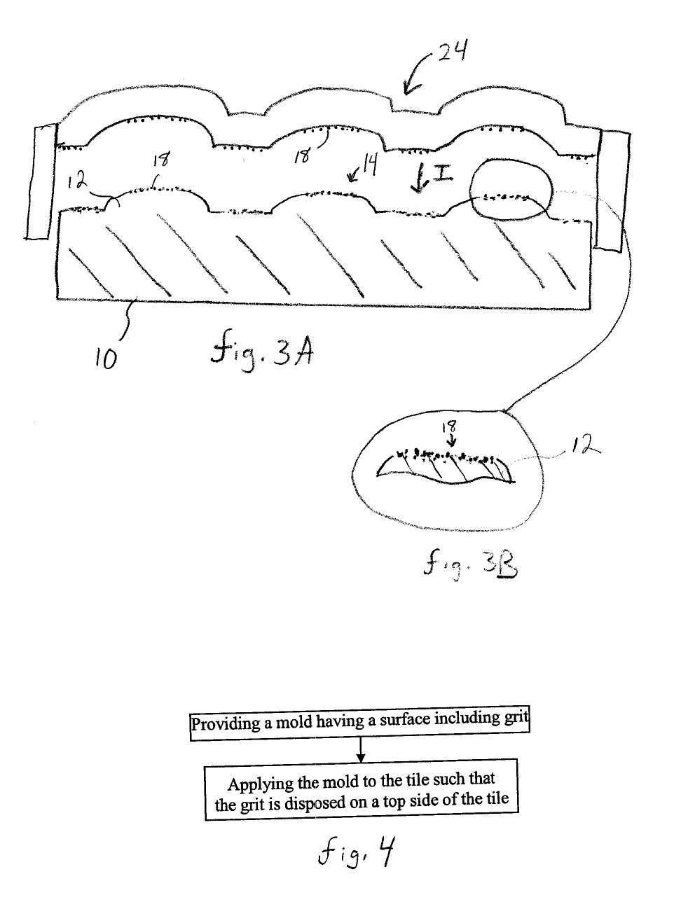

As used herein, the term “grit” indicates minute, rough granules. For example, sand, metal shavings, and/or finely crushed stone can be referred to as grit. Preferable, grit 18 is disposed upon substantially the entire planar surface of tile 10 and is integrally formed in the top side (as shown in FIG. 3B) during the manufacturing process.

As seen in the magnified side views FIGS. 3A and 3B of the embodiment shown in FIG. 2, the detectable warning tile 10 includes protuberances 12 and grit 18 disposed on top side 14. 2. Preferably, the grit 18 is between 1 micrometer and 3 millimeters in diameter.

For detectable warning tile applications, the tiles typically are composed of a cementitious material. However, the invention may be used in conjunction with many other types of materials. Furthermore, the protuberances 12 also may include an abrasive surface of grit. Thus, substantially the entire top side of a tile can be imparted with improved slip resistance.

The grit 18 may be applied to the top side 14 of tile 10. Alternatively, grit may be transferred or imprinted as an abrasive or roughened surface (as indicated by arrow I in FIG. 3A) by a mold or stamp 24 having grit 18 thereon.

FIG. 4 illustrates in flow diagram the basic steps of an embodiment of a method of the invention. A tile is cast in a mold having a surface including grit such that the grit is disposed on a top side of the tile. The grit may be disposed upon the planer tile surface and/or upon the protuberances (if the tile is of the detectable warning tile variety).

In another embodiment, the method for making a tile includes the steps of providing a mold or stamp having a surface including grit and contacting the grit of the mold or stamp to a top side of the tile. The grit may be transferred to the tile surface and/or may form an imprint into the unhardened tile surface. In this manner, a tile with improved slip resistance properties is formed.

Preferably, the basic method above further includes the step of applying material comprising abrasive veneers (such as sand paper) to create the grit that is applied to or stamped upon the top of the top side of the tile.

Various changes in the details that have been described may be made by those skilled in the art within the principles and scope of the invention herein described in the specification and defined in the appended claims. Therefore, while the present invention has been shown and described herein in what is believed to be the most practical and preferred embodiments, it is recognized that departures can be made therefrom within the scope of the invention, which is not to be limited to the details disclosed herein but is to be accorded the full scope of the claims so as to embrace any and all equivalent processes and products.

What is claimed is:

1. A tile arrangement, comprising:
a tile having a top side including a plurality of protuberances, wherein said top side includes an abrasive surface of grit.

2. The tile arrangement of claim 1, wherein said grit comprises granular particles of between 1 micrometer and 3 millimeters in diameter.

3. The tile arrangement of claim 1, wherein said plurality of protuberances comprise an array of one or more structures selected from the group consisting of studs, domes, and truncated domes.

4. The tile arrangement of claim 1, wherein said tile is composed of a cementitious material.

5. The tile arrangement of claim 1, wherein said protuberances include an abrasive surface of grit.

6. The tile arrangement of claim 1, wherein said grit is integrally formed in said top side.

7. A method for making a tile, comprising the steps of:
(a) providing a mold or stamp having a surface including grit; and
(b) contacting said grit of the mold or stamp to a top side of said tile.

8. The method of claim 7, wherein said contacting step imprints grit upon said top side of said tile.

9. The method of claim 7, wherein said grit comprises granular particles of between 1 micrometer and 3 millimeters in diameter.

10. The method of claim 8, wherein said grit imprint comprises granular particles of between 1 micrometer and 3 millimeters in diameter.

11. The method of claim 7, wherein said tile is cast from a cementitious material.

12. The method of claim 7, wherein said mold or stamp additionally has a surface for forming a plurality of protuberances and said casting step additionally forms a plurality of protuberances upon said top side of the tile.

13. The method of claim 12, wherein said contacting step comprises the formation of an array of one or more structures selected from the group consisting of studs, domes, and truncated domes upon said top side of the tile.

14. The method of claim 12, wherein said mold or stamp includes grit on said surface of the mold or stamp that forms said plurality of protuberances.

15. A tile having a top side including a plurality of protuberances, wherein said top side has a abrasive surface formed by grit being imprinted thereon.

16. The tile of claim 15, wherein said grit is imprinted by a mold or stamp.

17. The tile of claim 16, wherein said grit is formed on said mold or stamp by machining.

18. The tile of claim 15, wherein said grit comprises granular particles of between 1 micrometer and 3 millimeters in diameter.

19. The tile of claim 15, wherein said plurality of protuberances comprise an array of one or more structures selected from the group consisting of studs, domes, and truncated domes.

20. The tile of claim 15, wherein said tile is composed of a cementitious material.

21. The tile of claim 15, wherein said protuberances include an abrasive surface of grit.
